(19) United States
(12) Patent Application Publication
(10) Pub. No.: US 2010/0006567 A1
(43) Pub. Date: Jan. 14, 2010

(54) COOKING PACKAGE

(76) Inventor: Lorin R. Cole, Larsen, WI (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/502,359

(22) Filed: Jul. 14, 2009

Related U.S. Application Data
(60) Provisional application No. 61/080,436, filed on Jul. 14, 2008.

(51) Int. Cl. H05B 6/80; B65D 25/04; B65D 5/00; B65D 5/54; B31B 3/00

(52) U.S. Cl. 219/730; 229/120.02; 229/149; 229/200; 493/52

(57) ABSTRACT

A package for heating a food product in a microwave oven. The package has a tray for holding the food product, a lid foldably connected to the tray, and a partition at least partially received in the tray. The partition separates an interior space of the tray into a first compartment and a second compartment. At least one of the lid and the partition comprises a microwave interactive material.

### CROSS-REFERENCE TO RELATED APPLICATION

This application claims the benefit of U.S. Provisional Application No. 61/080,436 which was filed on Jul. 14, 2008. The entire content of the above-referenced provisional application is hereby incorporated by reference as if presented herein in its entirety.

### BACKGROUND OF THE DISCLOSURE

The present disclosure relates to the field of food preparation, and in particular, relates to materials and constructs that may be used to prepare foods in a microwave oven.

### SUMMARY OF THE DISCLOSURE

In general, one aspect of the disclosure is generally directed to a package that may be used for heating a food product in a microwave oven. In one example, the package comprises a tray for holding the food product, a lid foldably connected to the tray, and a partition at least partially received in the tray. The partition separates an interior space of the tray into a first compartment and a second compartment. At least one of the lid and the partition comprises a microwave interactive material.

In another aspect, the disclosure is generally directed to a package for heating a first food product and a second food product in a microwave oven. The package comprises a tray having an interior space for holding the first food product and the second food product, a lid foldably connected to the tray, and a partition at least partially received in the tray. The partition separates the interior space into a first compartment for holding the first food product and a second compartment for holding the second food product.

In another aspect, the disclosure is generally directed to a carton blank for forming a carton in combination with a partition blank for forming a partition. The carton blank and the partition blank cooperate to form a package for heating a first food product and a second food product in a microwave oven. The carton blank comprises a bottom panel, a first side panel foldably connected to the bottom panel, and a second side panel foldably connected to the bottom panel. The first side panel and the second side panel are for being positioned relative to the bottom panel to form a tray in the carton formed from the carton blank. The carton blank comprises a top panel foldably connected to the first side panel, a first end flap foldably connected to the top panel, a second end flap foldably connected to the top panel, and a third end flap foldably connected to the top panel. The first end flap, the second end flap, and the third end flap are for being positioned relative to the top panel to form a lid in the carton formed from the carton blank. The partition blank comprises a first bottom panel, at least one divider panel foldably connected to the first bottom panel, and a second bottom panel foldably connected to the at least one divider panel. The at least one divider panel is for forming a divider that extends upwardly from the first bottom panel and second bottom panel.

In another aspect, the disclosure is generally directed to a method of forming a package. The method comprises obtaining a carton blank comprising a bottom panel, a first side panel foldably connected to the bottom panel, a second side panel foldably connected to the bottom panel, a top panel foldably connected to the first side panel, a first end flap foldably connected to the top panel, a second end flap foldably connected to the top panel, and a third end flap foldably connected to the top panel. The method comprises forming a tray having an interior space by positioning the first side panel and the second side panel relative to the bottom panel, and forming a lid foldably connected to the tray by positioning the first end flap, the second end flap, and the third end flap relative to the top panel. The method comprises obtaining a partition blank comprising a first bottom panel, at least one divider panel foldably connected to the first bottom panel, and a second bottom panel foldably connected to the at least one divider panel. The method comprises forming a partition from the partition blank by positioning the at least one divider panel relative to the first bottom panel and the second bottom panel, and placing the partition into the tray to separate the interior space into a first compartment and a second compartment.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a plan view of an exterior surface of a carton blank according to one embodiment of the disclosure.

FIG. 2 is a plan view of an interior surface of the carton blank of FIG. 1.

FIG. 3 is a perspective view of the carton blank partially assembled into a carton.

FIG. 4 is a plan view of an exterior surface of a partition blank.

FIG. 4A is a perspective view of the partition blank formed into a partition.

FIG. 5 is a perspective view of the carton and the partition.

FIG. 6 is a perspective view of the carton and the partition partially assembled into a package of one embodiment t of the disclosure.

FIG. 7 is a perspective view of the package assembled from the carton and the partition of FIG. 6.

FIG. 8 is a perspective view of the package with an access panel in an opened position allowing access to a first food product and a second food product in the package.

Corresponding parts are designated by corresponding reference numbers throughout the drawings.

### DETAILED DESCRIPTION OF THE EXEMPLARY EMBODIMENTS

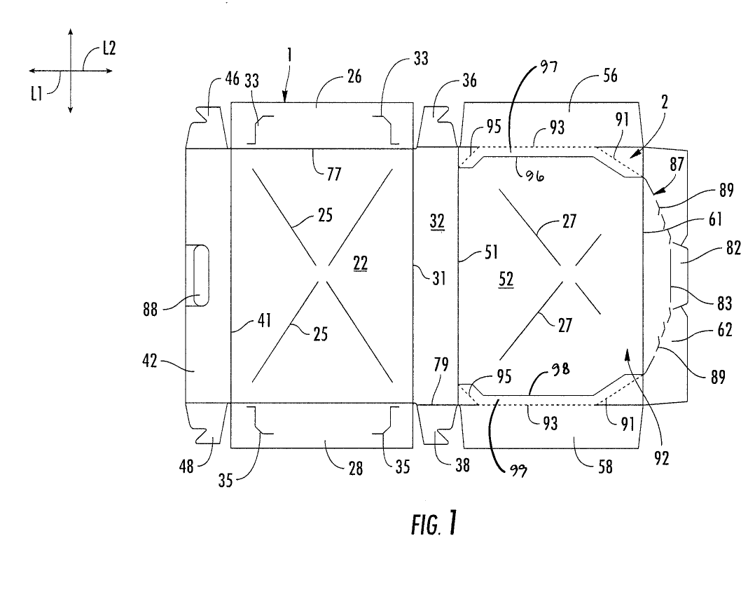

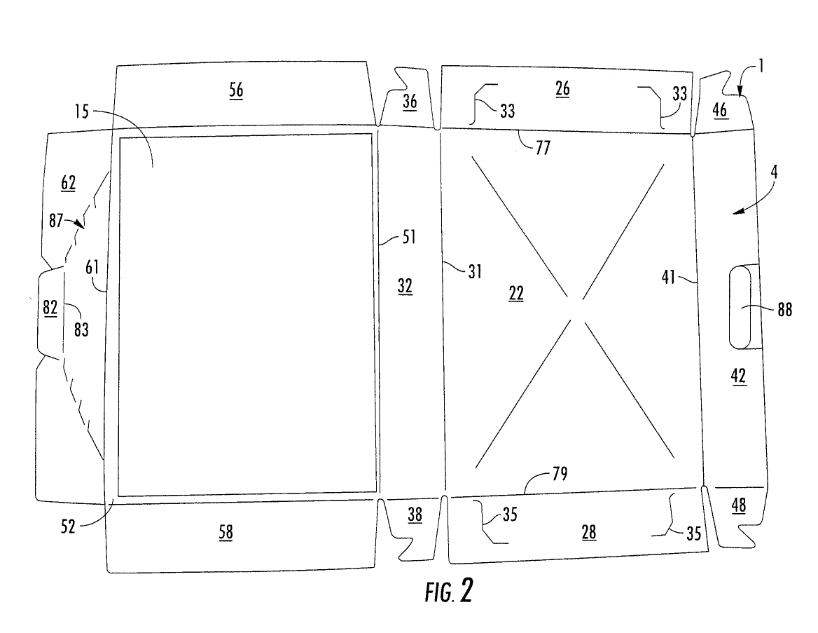

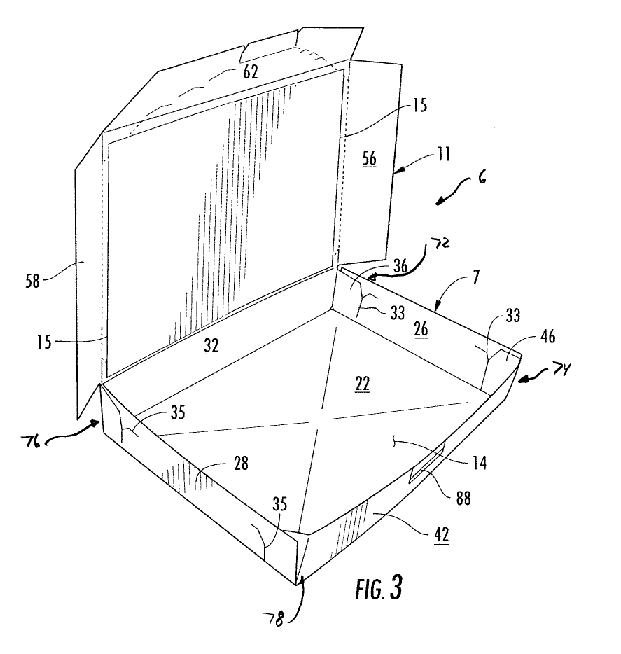

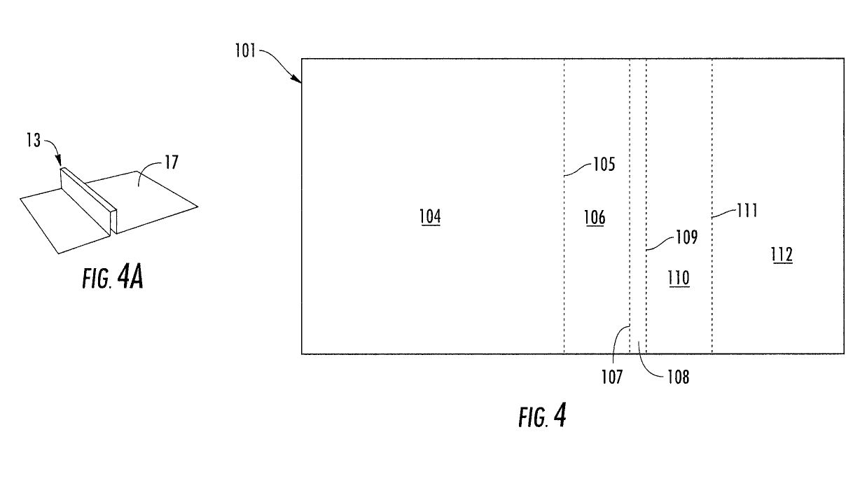

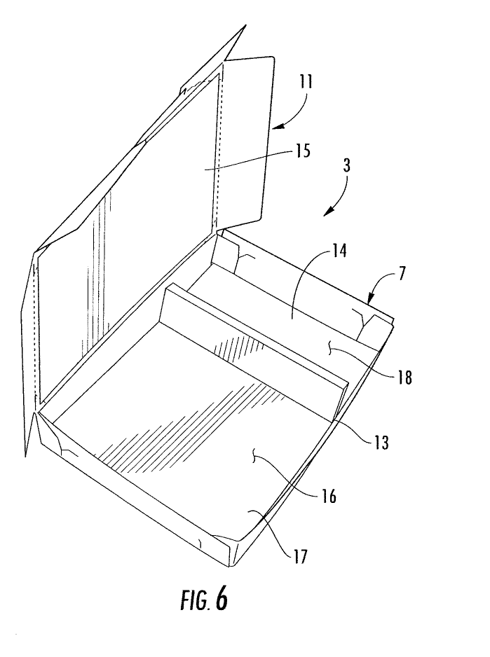

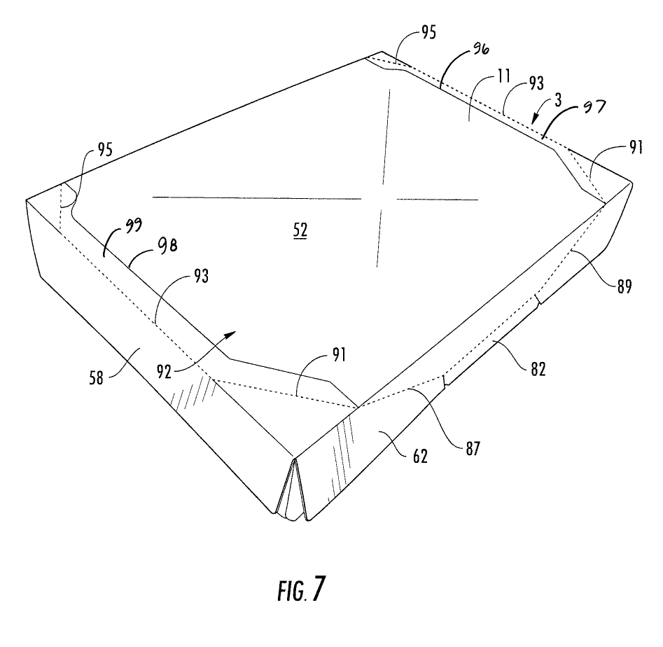

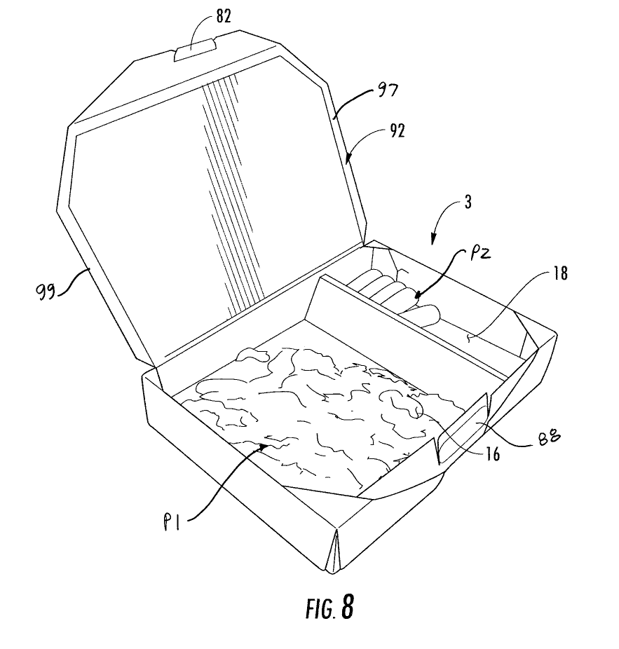

FIG. 1 is a plan view of an exterior surface 2 of a carton blank 1 used to form a package 3 (FIG. 7) of one embodiment of the disclosure. FIG. 2 shows an interior surface 4 of the blank 1. As shown in FIG. 8, the package 3 can be used to hold a first food product P1 (e.g., scrambled eggs) and a second food product P2 (e.g., sausage) during cooking or reheating of the food products. Alternatively the food products P1, P2, could be any other suitable food products (e.g., waffles, pancakes, hash browns, bacon, burrito, sandwich, nachos, or any other food product). In one example, the package 3 with food products P1, P2 is placed in a microwave oven (not shown) to heat and/or cook the food products. As shown in FIG. 3, the package 3 includes a carton 6 formed from the carton blank and having a tray 7 that is sized to hold the food products P1, P2, and a lid 11 foldably connected to the tray. The package 3 comprises a partition 13 located in an interior space 14 of the tray. As shown in FIGS. 6 and 8, the partition 13 divides the interior space 14 of the tray into a first portion 16 for holding the first food product P1 and a second portion 18 for holding the second food product P2. The lid 11 may have an element 15 for use in cooking, heating, browning, and/or shielding (e.g., a microwave energy interactive element 15 such as, but not limited to, a susceptor) mounted thereto. It is understood that the microwave energy interactive element 15 (FIG. 2) may be omitted from the package 3. The partition 13 may have an element 17 (FIGS. 4A and 6) for use in cooking, heating, browning, and/or shielding (e.g., a microwave energy interactive element 17 such as, but not limited to, a susceptor) mounted thereto. It is understood that the microwave energy interactive element 17 may be omitted from the package 3.

The carton blank 1 has a longitudinal axis L1 and a lateral axis L2. The blank 1 includes a bottom panel 22 foldably connected to a first side panel 32 at a lateral fold line 31. A second side panel 42 is foldably connected to the bottom panel 22 at a lateral fold line 41. A top panel 52 is foldably connected to the first side panel 32 at a lateral fold line 51. An adhesive flap (broadly “end flap”) 62 is foldably connected to the top panel 52 at a lateral fold line 61. In the illustrated embodiment, the bottom panel 22 and top panel 52 have respective oblique score lines 25, 27 to allow the panels to flex.

In the illustrated embodiment, the bottom panel 22 includes two end flaps 26, 28 foldably connected to opposite ends of the bottom panel. The first side panel 32 has two end flaps 36, 38 foldably connected to opposite ends of the first side panel. The second side panel 42 has two end flaps 46, 48 foldably connected to opposite ends of the second side panel. The top panel 52 has two end flaps 56, 58 foldably connected to opposite ends of the top panel. When the carton 6 is erected, the end flaps 26, 36, 46, 56 close a first end 71 of the carton, and the end flaps 28, 38, 48, 58, close a second end 73 of the carton. In accordance with an alternative embodiment of the present disclosure, different panel and flap arrangements can be used for closing the carton 6. The end flaps 56, 58 and the adhesive flap 62 cooperate with the top panel 52 to form the lid 11.

The end flaps 26, 36, 46, 56 extend along a first marginal area of the blank 1, and are foldably connected at a first longitudinal fold line 77 that extends along the length of the blank. The end flaps 28, 38, 48, 58 extend along a second marginal area of the blank 1, and are foldably connected at a second longitudinal fold line 79 that extends along the length of the blank. The longitudinal fold lines 77, 79 may be, for example, substantially straight, or offset at one or more locations to account for blank thickness or for other factors. The end flaps 26, 28 include respective cuts 33, 35. The cuts 33 in the end flap 26 are for receiving a respective one of the end flaps 36, 46 to form a respective corner 72, 74 (FIG. 3) of the tray 7. The cuts 35 in the end flaps 28 are for receiving a respective one of the end flaps 38, 48 to form a respective corner 76, 78 (FIG. 3) of the tray 7. Alternatively, the corners 72, 74, 76, 78 may be formed differently.

In the illustrated embodiment, the adhesive flap 62 includes a closure tab 82 foldably attached to the adhesive flap at a lateral fold line 83. The carton blank 1 includes a tear line 87 in the adhesive flap 62 and the top panel 52. The tear line includes first oblique portions 89 generally extending from respective sides of the closure tab 82 to the lateral fold line 61. The tear line 87 has second oblique portions 91 in the top panel 52 that extend from the lateral fold line 61 to a respective longitudinal fold line 77, 79. A longitudinal portion 93 of the tear line 87 extends along respective portions of the longitudinal fold lines 77, 79. A third oblique portion 95 of the tear line extends from a respective longitudinal portion 93 to the lateral fold line 51. The tear line 87 forms a access panel 92 of the lid 11 that is for at least partially being removed from the lid for opening the package 3. In the illustrated embodiment, the access panel 92 comprises a portion of the top panel 52 and a portion of the adhesive flap 62, but the access panel could be otherwise shaped, arranged, and/or configured. In one embodiment, the top panel 52 has a respective fold line 96, 98 adjacent to and spaced apart from the portions 91, 93, 95 of the tear line 87 and extending between the fold lines 51, 61. The fold lines 96, 98 allow respective edge portions 97, 99 of the access panel 92 to flex when opening and closing the access panel. The package 3 could omit or comprise other opening and/or dispensing features without departing from the scope of this disclosure. In the illustrated embodiment, the second side panel 42 has a retention feature in the form of a retention opening 88 that cooperates with the closure tab 82 of the adhesive flap 62 to retain the lid 11 in the closed position when the closure tab is received in the retention opening.

In the illustrated embodiment, the microwave interactive element 15 of the carton blank 1 covers, at least in part, (e.g., substantially all of) the interior surface of the top panel 52. In one embodiment, the microwave interactive element 15 is a generally rectangular panel that is attached to the blank 1 by adhesive material (not shown) or by an other acceptable mechanism.

The material of the microwave interactive element 15 can be, or include, any type of known microwave interactive material, such as a susceptor that is for absorbing microwave energy and/or converting microwave energy into thermal energy to thereby become hot and to at least radiantly provide heat to food, a microwave energy shielding element that is for reflecting microwave energy away from at least a portion of a food item, a microwave energy directing element for directing microwave energy toward at least a portion of a food item, and various combinations of these and other features. In accordance with exemplary embodiments of the present disclosure, the material of the microwave interactive element 15 can more specifically be a microwave insulating material in contact with the food product for heating, browning, and/or crisping the food product during operation of the microwave oven. It is understood that the food product may be a type of food product that may or may not require browning or crisping during microwave heating. The food product may be cooked or heated from the frozen, refrigerated or room temperature states with the appropriate microwave interactive element 15, 17 that can be any suitable material such as discussed herein or any other suitable material.

FIG. 4 shows a partition blank 101 used to form the partition 13 (FIG. 4A) of the package 3. In the illustrated embodiment, the blank 101 includes a first bottom panel 104 foldably connected to a first divider panel 106 at a fold line 105, a top panel 108 foldably connected to the first divider panel 106 at a fold line 107, a second divider panel 110 foldably connected to the top panel at a fold line 109, and a second bottom panel 112 foldably connected to the second divider panel at a fold line 111. In the illustrated embodiment, the blank 101 includes a microwave interactive element 17 on substantially all of the exterior surface of the blank The microwave interactive element 17 may be otherwise shaped, arranged, or omitted without departing from the scope of this disclosure. The microwave interactive element 17 may be like the microwave interactive element 15 discussed above, and these microwave interactive elements are also discussed in greater detail below.

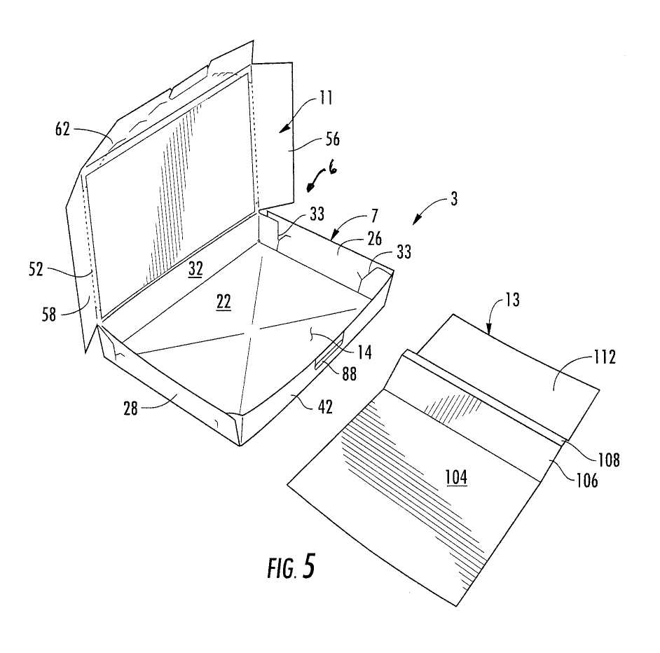

As shown in FIGS. 2-8, and described in the following in accordance with one acceptable example, the package 3 is formed from the blanks 1, 101 by first upwardly folding the side panels 32, 42 and end flaps 26, 28 relative to the bottom panel 22. The end flaps 36, 38, 46, 48 are inwardly folded and received in respective cuts 33, 35 to form the tray 7 (FIG. 3) from the carton blank 1. The partition 13 is formed by upwardly folding the first divider panel 106 relative to the first bottom panel 104 and upwardly folding the second divider panel 110 relative to the second bottom panel 112 so that the top panel 108 is spaced above, and in parallel, planar relationship with the first and second bottom panels (FIG. 6). The lid 11 is formed from the carton blank 1 by folding the end flap 56, 58 and adhesive flap 62 relative to the top panel 52. Next the partition 13 is place in the interior space 14 of the tray 7 so that the first and second bottom panels 104, 112 are in face-to-face contact with the bottom panel 22 of the tray (FIG. 6). In the position of FIG. 6, the first and second divider panels 106, 110 and the top panel 108 divide the interior space 14 of the package 3 into the first portion 16 and second portion 18. Food products P1, P2 are placed in the first and second portions 16, 18 of the interior space 14 and the lid 11 is closed by folding the lid at fold line 51. In the closed position, the end flaps 56, 58 of the lid 11 overlap the end flaps 26, 28 of the tray 7 and the adhesive panel 62 overlaps the second side panel 42. The two end flaps 56, 58 and/or the adhesive panel 62 can be secured to a corresponding portion of the tray 7 by adhesive such as glue. The lid 11 can be secured in the closed position by alternative attachment mechanisms. In the closed and secured position of FIG. 7, the package with food products P1, P2 held therein can be shipped to the point-of-sale location (e.g., grocery story).

Once a consumer has purchased the package 3 and is ready to cook or heat the food products P1, P2, the package may be opened by tearing along tear line 87 to at least partially remove the access panel 92 from the lid 11 (FIG. 8). The opened package 3 can be placed in a microwave oven (not shown) so that the food products P1, P2 may be heated by the microwave interactive elements 15, 17 of the package. The access panel 92 may be lowered into the tray 7 so that the microwave interactive element is in close proximity to the food products P1, P2 when heating the food products P. The access panel 92 can be retained in the lowered position by inserting the closure tab 82 into the retention opening 88. Alternatively, the package 3 can be used to heat the food products P1, P2 prior to opening the access panel 92, and the access panel can be opened to gain access to the heated food products. The heated food products P1, P2 can remain in the tray 7 for consumption by the consumer or the food products can be removed from the package and placed on a serving dish or plate (not shown). Alternatively, the access panel 92 can be fully removed from the tray 7 at any point of the heating and/or consumption process.

For convenience, food items and packages are described herein as having a top, bottom, and sides. In many instances, the top, bottom, and sides of a package or a food item are relative to a surface the food item is placed on and the perspective of the viewer. It should be understood that reference to a top, bottom, or side is not meant to impart any particular limitation on the scope of the disclosure, but merely provide an easy way to refer to describe the features thereof.

Various microwave energy interactive elements may be suitable for use with the package. For example, the microwave energy interactive elements may promote browning and/or crisping of a particular area of the food item, shield a particular area of the food item from microwave energy to prevent overcooking thereof, or transmit microwave energy towards or away from a particular area of the food item. Each microwave interactive element comprises one or more microwave energy interactive materials or segments arranged in a particular configuration to absorb microwave energy, transmit microwave energy, reflect microwave energy, or direct microwave energy, as needed or desired for a particular construct and food item.

The microwave interactive element may be supported on a microwave inactive or transparent substrate for ease of handling and/or to prevent contact between the microwave interactive material and the food item. As a matter of convenience and not limitation, and although it is understood that a microwave interactive element supported on a microwave transparent substrate includes both microwave interactive and microwave inactive elements or components, such constructs are referred to herein as “microwave interactive webs”.

The microwave energy interactive material may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable for use with the present disclosure include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide. Examples of metal oxides that may be suitable for use with the present disclosure include, but are not limited to, oxides of aluminum, iron, and tin, used in conjunction with an electrically conductive material where needed. Another example of a metal oxide that may be suitable for use with the present disclosure is indium tin oxide (ITO). ITO can be used as a microwave energy interactive material to provide a heating effect, a shielding effect, a browning and/or crisping effect, or a combination thereof. For example, to form a susceptor, ITO may be sputtered onto a clear polymeric film. The sputtering process typically occurs at a lower temperature than the evaporative deposition process used for metal deposition. ITO has a more uniform crystal structure and, therefore, is clear at most coating thicknesses. Additionally, ITO can be used for either heating or field management effects. ITO also may have fewer defects than metals, thereby making thick coatings of ITO more suitable for field management than thick coatings of metals, such as aluminum.

Alternatively, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In one example, the microwave interactive element may comprise a thin layer of microwave interactive material that tends to absorb microwave energy, thereby generating heat at the interface with a food item. Such elements often are used to promote browning and/or crisping of the surface of a food item (sometimes referred to as a “browning and/or crisping element”). When supported on a film or other substrate, such an element may be referred to as a “susceptor film” or, simply, “susceptor”. However, other microwave energy interactive elements, such as those described herein, are contemplated hereby.

As another example, the microwave interactive element may comprise a foil having a thickness sufficient to shield one or more selected portions of the food item from microwave energy (sometimes referred to as a “shielding element”). Such shielding elements may be used where the food item is prone to scorching or drying out during heating.

The shielding element may be formed from various materials and may have various configurations, depending on the particular application for which the shielding element is used. Typically, the shielding element is formed from a conductive, reflective metal or metal alloy, for example, aluminum, copper, or stainless steel. The shielding element generally may have a thickness of from about 0.000285 inches to about 0.05 inches. In one aspect, the shielding element has a thickness of from about 0.0003 inches to about 0.03 inches. In another aspect, the shielding element has a thickness of from about 0.00035 inches to about 0.020 inches, for example, 0.016 inches.

As still another example, the microwave interactive element may comprise a segmented foil, such as, but not limited to, those described in U.S. Pat. Nos. 6,204,492, 6,433,322, 6,552,315, and 6,677,563, each of which is incorporated by reference in its entirety. Although segmented foils are not continuous, appropriately spaced groupings of such segments often act as a transmitting element to direct microwave energy to specific areas of the food item. Such foils also may be used in combination with browning and/or crisping elements, for example, susceptors.

Any of the numerous microwave interactive elements described herein or contemplated hereby may be substantially continuous, that is, without substantial breaks or interruptions, or may be discontinuous, for example, by including one or more breaks or apertures that transmit microwave energy therethrough. The breaks or apertures may be sized and positioned to heat particular areas of the food item selectively. The number, shape, size, and positioning of such breaks or apertures may vary for a particular application depending on type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that the aperture may be a physical aperture or void in the material used to form the construct, or may be a non-physical “aperture”. A non-physical aperture may be a portion of the construct that is microwave energy inactive by deactivation or otherwise, or one that is otherwise transparent to microwave energy. Thus, for example, the aperture may be a portion of the construct formed without a microwave energy active material or, alternatively, may be a portion of the construct formed with a microwave energy active material that has been deactivated. While both physical and non-physical apertures allow the food item to be heated directly by the microwave energy, a physical aperture also provides a venting function to allow steam or other vapors to be released from the food item. It also may be beneficial to create one or more discontinuities or inactive regions to prevent overheating or charring of the carton.

As stated above, any of the above elements and numerous others contemplated hereby may be supported on a substrate. The substrate typically comprises for example, a polymer film or other polymeric material. As used herein the term “polymer” or “polymeric material” includes, but is not limited to, homopolymers, copolymers, such as for example, block, graft, random, and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic, and random symmetries.

The thickness of the film typically may be from about 35 gauge to about 10 mil. In one aspect, the thickness of the film is from about 40 to about 80 gauge. In another aspect, the thickness of the film is from about 45 to about 50 gauge. In still another aspect, the thickness of the film is about 48 gauge. Examples of polymeric films that may be suitable include, but are not limited to, polyolefins, polyesters, polyamides, polyimides, polysulfones, polyether ketones, cellophanes, or any combination thereof. Other non-conducting substrate materials such as paper and paper laminates, metal oxides, silicates, cellulosics, or any combination thereof, also may be used.

In one example, the polymeric film comprises polyethylene terephthalate (PET). Polyethylene terephthalate films are used in commercially available susceptors, for example, the QWIKWAVE® susceptor and the MICRORITE® susceptor laminations, both available from Graphic Packaging International (Marietta, Ga.). Examples of polyethylene terephthalate films that may be suitable for use as the substrate include, but are not limited to, MELINEX® films, commercially available from DuPont Teijan Films (Hopewell, Va.), SKYROL films, commercially available from SKC, Inc. (Covington, Ga.), and BARRIALOX PET films, available from Toray Films (Front Royal, Va.), and QU50 High Barrier Coated PET films, available from Toray Films (Front Royal, Va.).

The polymeric film may be selected to impart various properties to the paper or paperboard web, for example, printability, heat resistance, or any other property. As one particular example, the polymeric film may be selected to provide a water barrier, oxygen barrier, or a combination thereof. Such barrier film layers may be formed from a polymer film having barrier properties or from any other barrier layer or coating as desired. Suitable polymer films may include, but are not limited to, ethylene vinyl alcohol, barrier nylon, polyvinylidene chloride, barrier fluoropolymer, nylon 6, nylon 6,6, coextruded nylon 6/EVOH/nylon 6, silicon oxide coated film, barrier polyethylene terephthalate, or any combination thereof.

One example of a barrier film that may be suitable for use with the present disclosure is CAPRAN® EMBLEM 1200M nylon 6 film, commercially available from Honeywell International (Pottsville, Pa.). Another example of a barrier film that may be suitable is CAPRAN® OXYSHIELD OBS monoaxially oriented coextruded nylon 6/ethylene vinyl alcohol (EVOH)/nylon 6 film, also commercially available from Honeywell International. Yet another example of a barrier film that may be suitable for use with the present disclosure is DARTEK® N-201 nylon 6,6 film, commercially available from Enhance Packaging Technologies (Webster, N.Y.). Additional examples include BARRIALOX PET film, available from Toray Films (Front Royal, Va.) and QU50 High Barrier Coated PET film, available from Toray Films (Front Royal, Va.), referred to above.

Still other barrier films include silicon oxide coated films, such as those available from Sheldahl Films (Northfield, Minn.). Thus, in one example, a susceptor may have a structure including a film, for example, polyethylene terephthalate, with a layer of silicon oxide coated onto the film, and ITO or other material deposited over the silicon oxide. If needed or desired, additional layers or coatings may be provided to shield the individual layers from damage during processing.

The barrier film may have an oxygen transmission rate (OTR) as measured using ASTM D3985 of less than about 20 cc/m2/day. In one aspect, the barrier film has an OTR of less than about 10 cc/m2/day. In another aspect, the barrier film has an OTR of less than about 1 cc/m2/day. In still another aspect, the barrier film has an OTR of less than about 0.5 cc/m2/day. In yet another aspect, the barrier film has an OTR of less than about 0.1 cc/m2/day.

The barrier film may have a water vapor transmission rate (WVTR) of less than about 100 g/m2/day as measured using ASTM F1249. In one aspect, the barrier film has a water vapor transmission rate of less than about 50 g/m2/day. In another aspect, the barrier film has a WVTR of less than about 15 g/m2/day. In yet another aspect, the barrier film has a WVTR of less than about 1 g/m2/day. In still another aspect, the barrier film has a WVTR of less than about 0.1 g/m2/day. In a still further aspect, the barrier film has a WVTR of less than about 0.05 g/m2/day.

Other non-conducting substrate materials such as metal oxides, silicates, cellulosics, or any combination thereof, also may be used in accordance with the present disclosure.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item.

The microwave interactive element or microwave interactive web may be joined to or overlie a dimensionally stable, microwave energy transparent support (hereinafter referred to as “microwave transparent support”, “microwave inactive support” or “support”) to form the construct. In another aspect, where a more flexible construct is to be formed, the support may comprise a paper or paper-based material generally having a basis weight of from about 15 to about 60 lbs/ream, for example, from about 20 to about 40 lbs/ream. In one particular example, the paper has a basis weight of about 25 lbs/ream.

Optionally, one or more portions of the various blanks or other constructs described herein or contemplated hereby may be coated with varnish, clay, or other materials, either alone or in combination. For example, the microwave energy interactive material may be provided as a continuous or discontinuous layer or coating including circles, loops, hexagons, islands, squares, rectangles, octagons, and so forth. Examples of various patterns and methods that may be suitable for use with the present disclosure are provided in U.S. Pat. Nos. 7,019,271; 6,765,182; 6,717,121; 6,677,563; 6,552,315; 6,455,827; 6,433,322; 6,414,290; 6,251,451; 6,204,492; 6,150,646; 6,114,679; 5,800,724; 5,759,422; 5,672,407; 5,628,921; 5,519,195; 5,424,517; 5,410,135; 5,354,973; 5,340,436; 5,266,386; 5,260,537; 5221,419; 5,213,902; 5,117,078; 5,039,364; 4,963,424; 4,936,935; 4,890,439; 4,775,771; 4,865,921; and Re. 34,683, each of which is incorporated by reference herein in its entirety. Although particular examples of patterns of microwave energy interactive material are shown and described herein, it should be understood that other patterns of microwave energy interactive material are contemplated by the present disclosure.

In one aspect, for example, where a rigid or semi-rigid construct is to be formed, all or a portion of the support may be formed at least partially from a paperboard material, which may be cut into a blank prior to use in the construct. For example, the support may be formed from paperboard having a basis weight of from about 60 to about 330 lbs/ream (i.e., lbs/3,000 ft²), for example, from about 80 to about 140 lbs/ream. The paperboard generally may have a thickness of from about 6 to about 30 mils, for example, from about 12 to about 28 mils. In one particular example, the paperboard has a thickness of about 18 mils and a basis weight of from about 100 lbs/ream to about 300 lbs/ream. Any suitable paperboard may be used, for example, a solid bleached or solid unbleached sulfate board, such as SUS® board, commercially available from Graphic Packaging International.

Furthermore, the blanks or other constructs may be coated with, for example, a moisture and/or oxygen barrier layer, on either or both sides, such as those described above. Any suitable moisture and/or oxygen barrier material may be used in accordance with the present disclosure. Examples of materials that may be suitable include, but are not limited to, polyvinylidene chloride, ethylene vinyl alcohol, DuPont DARTEK™ nylon 6,6 film, and others referred to above.

Alternatively or additionally, any of the blanks, packages, or other constructs of the present disclosure may be coated or laminated with other materials to impart other properties, such as absorbency, repellency, opacity, color, printability, stiffness, or cushioning. For example, absorbent susceptors are described in U.S. Provisional Application No. 60/604,637, filed Aug. 25, 2004, U.S. patent application Ser. No. 11/211,858, filed Aug. 25, 2005, and U.S. patent application Ser. Nos. 11/673,136 and 11/673,130, filed Feb. 9, 2007, all of which are incorporated herein by reference in their entirety. Additionally, the blanks or other constructs may include graphics or indicia printed thereon.

It will be understood that with some combinations of elements and materials, the microwave interactive element may have a grey or silver color this that is visually distinguishable from the substrate or the support. However, in some instances, it may be desirable to provide a web or construct having a uniform color and/or appearance. Such a web or construct may be more aesthetically pleasing to a consumer, particularly when the consumer is accustomed to packages or containers having certain visual attributes, for example, a solid color, a particular pattern, and so on. Thus, for example, the present disclosure contemplates using a silver or grey toned adhesive to join the microwave interactive elements to the substrate, using a silver or grey toned substrate to mask the presence of the silver or grey toned microwave interactive element, using a dark toned substrate, for example, a black toned substrate, to conceal the presence of the silver or grey toned microwave interactive element, overprinting the metallized side of the web with a silver or grey toned ink to obscure the color variation, printing the non-metallized side of the web with a silver or grey ink or other concealing color in a suitable pattern or as a solid color layer to mask or conceal the presence of the microwave interactive element, or any other suitable technique or combination thereof.

The blanks according to the present disclosure can be, for example, formed from coated paperboard and similar materials. For example, the interior and/or exterior sides of the blank can be coated with a clay coating. The clay coating may then be printed over with product, advertising, price coding, and other information or images. The blank may then be coated with a varnish to protect any information printed on the blank. The blank may also be coated with, for example, a moisture barrier layer, on either or both sides of the blank. In accordance with the above-described embodiments, the blank may be constructed of paperboard of a caliper such that it is heavier and more rigid than ordinary paper. The blank can also be constructed of other materials, such as cardboard, hard paper, or any other material having properties suitable for enabling the carton to function at least generally as described herein. The blank can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines may include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, cut line, or the like. For example, a cut line can be a continuous slit or could be wider than a slit without departing from the present disclosure.

The foregoing description illustrates and describes various embodiments of the present disclosure. As various changes could be made in the above construction, it is intended that all matter contained in the above description or shown in the accompanying drawings shall be interpreted as illustrative and not in a limiting sense. It will be understood by those skilled in the art that while the present disclosure has been discussed above with reference to exemplary embodiments, various additions, modifications and changes can be made thereto without departing from the spirit and scope of the disclosure.

What is claimed is:

1. A package for heating a first food product and a second food product in a microwave oven, the package comprising:
a tray having an interior space for holding the first food product and the second food product;
a lid foldably connected to the tray; and
a partition at least partially received in the tray, the partition separates the interior space into a first compartment for holding the first food product and a second compartment for holding the second food product.

2. The package of claim 1 wherein the tray comprises a bottom panel for supporting the food product, a first side panel foldably connected to the bottom panel, and a second side panel foldably connected to the bottom panel, the first and second side panel being positioned relative to the bottom panel to form the tray.

3. The package of claim 2 wherein the tray comprises end flaps foldably connected to a respective bottom panel, first side panel, and second side panel, the end flaps cooperate with the bottom panel, the first side panel, and the second side panel and are positioned relative to the bottom panel to form the tray.

4. The package of claim 3 wherein the end flaps connected to the bottom panel have respective cuts for at least partially receiving one of the end flaps foldably connected to one of the first side panel and the second side panel to form respective corners of the tray.

5. The package of claim 2 wherein the lid is foldably connected to one of the first side panel and the second side panel.

6. The package of claim 5 wherein the lid comprises a top panel foldably connected to the first side panel, a first end flap foldably connected to the top panel, a second end flap foldably connected to the top panel, and a third end flap foldably connected to the top panel, the first end flap, the second end flap, and the third end flap are positioned relative to the top panel to form the lid.

7. The package of claim 6 wherein the lid comprises a tear line that forms an access panel in the package, the access panel comprises at least a portion of the top panel and at least a portion of at least one of the first end flap, the second end flap, and the third end flap.

8. The package of claim 6 wherein the third end flap comprises a closure tab and the second side panel comprises a retention opening for receiving the closure tab to retain the lid in a closed position.

9. The package of claim 2 wherein the partition comprises a first bottom panel, a first divider panel foldably connected to the first bottom panel, a top panel foldably connected to the first divider panel, a second divider panel foldably connected to the top panel, and a second bottom panel foldably connected to the second divider panel, the first divider panel, the top panel, and the second divider panel form a divider that extends upwardly from the first bottom panel and second bottom panel.

10. The package of claim 9 wherein the first bottom panel and the second bottom panel of the partition are in face-to-face contact with the bottom panel of the tray.

11. The package of claim 1 further comprising a microwave interactive element attached to at least one of the lid and the partition.

12. In combination, a carton blank for forming a carton and a partition blank for forming a partition that cooperates with the carton to form a package for heating a first food product and a second food product in a microwave oven,
the carton blank comprises:
a bottom panel;
a first side panel foldably connected to the bottom panel;
a second side panel foldably connected to the bottom panel, the first side panel and the second side panel are for being positioned relative to the bottom panel to form a tray in the carton formed from the carton blank;
a top panel foldably connected to the first side panel;
a first end flap foldably connected to the top panel;
a second end flap foldably connected to the top panel; and
a third end flap foldably connected to the top panel, the first end flap, the second end flap, and the third end flap are for being positioned relative to the top panel to form a lid in the carton formed from the carton blank,
the partition blank comprises:
a first bottom panel;
at least one divider panel foldably connected to the first bottom panel; and
a second bottom panel foldably connected to the at least one divider panel, the at least one divider panel is for forming a divider that extends upwardly from the first bottom panel and second bottom panel.

13. The combination of claim 12 wherein the carton blank comprises end flaps respectively connected to a respective bottom panel, first side panel, and second side panel, the end flaps connected to the bottom panel have respective cuts for at least partially receiving one of the end flaps foldably connected to one of the first side panel and the second side panel.

14. The combination of claim 12 wherein the carton blank comprises a tear line in the top panel and at least one of the first end flap, the second end flap, and the third end flap, the tear line forms an access panel in the lid of the carton formed from the carton blank.

15. The combination of claim 12 wherein at least one of the carton blank and the partition blank comprises a microwave interactive element.

16. The combination of claim 12 wherein the at least one divider panel comprises a first divider panel and a second divider panel, and the partition blank comprises a top panel foldably connected to the first divider panel and the second divider panel, the first bottom panel being foldably connected to the first divider panel and the second bottom panel being foldably connected to the second bottom panel.

17. A method of forming a package comprising:
obtaining a carton blank comprising a bottom panel, a first side panel foldably connected to the bottom panel, a second side panel foldably connected to the bottom panel, a top panel foldably connected to the first side panel, a first end flap foldably connected to the top panel, a second end flap foldably connected to the top panel, and a third end flap foldably connected to the top panel;
forming a tray having an interior space by positioning the first side panel and the second side panel relative to the bottom panel;
forming a lid foldably connected to the tray by positioning the first end flap, the second end flap, and the third end flap relative to the top panel;
obtaining a partition blank comprising a first bottom panel, at least one divider panel foldably connected to the first bottom panel, and a second bottom panel foldably connected to the at least one divider panel;
forming a partition from the partition blank by positioning the at least one divider panel relative to the first bottom panel and the second bottom panel; and
placing the partition into the tray to separate the interior space into a first compartment and a second compartment.

18. The method of claim 17 further comprising placing a first food product in the first compartment and placing a second food product in the second compartment.

19. The method of claim 18 further comprising closing the package by folding the lid relative to the tray to at least partially enclose the first food product and the second food product.

20. The method of claim 19 wherein the carton blank comprises a tear line that forms an access panel in the package, the access panel comprises at least a portion of the top panel and at least a portion of at least one of the first end flap, the second end flap, and the third end flap, the method further comprises accessing the first food product and the second food product by opening the access panel.

21. The method of claim 17 wherein the carton blank comprises end flaps respectively foldably connected to a respective bottom panel, first side panel, and second side panel, wherein forming the tray comprises positioning the end flaps relative to the bottom panel.

22. The method of claim 20 wherein the end flaps connected to the bottom panel have respective cuts, the forming the tray comprises inserting the end flaps foldably connected to one of the first side panel and the second side panel into a respective cut to form respective corners of the tray.

23. The method of claim 17 wherein the placing the partition in the tray comprises placing the first bottom panel and the second bottom panel of the partition into face-to-face contact with the bottom panel of the tray.

24. The method of claim 17 wherein the at least one divider panel comprises a first divider panel and a second divider panel and the partition blank comprises a top panel foldably connected to the first divider panel and the second divider panel, the first bottom panel being foldably connected to the first divider panel and the second bottom panel being foldably connected to the second divider panel, the forming the partition comprises positioning the first divider panel, the second divider panel, and the top panel relative to the first bottom panel and the second bottom panel.
